(19) United States
(12) Patent Application Publication
(10) Pub. No.: US 2026/0361251 A1
(43) Pub. Date: Nov. 12, 2026

(54) FAULT TOLERANT AIRCRAFT ELECTRICAL PROPULSION SYSTEM

(71) Applicant: SAFRAN ELECTRICAL & POWER, Blagnac (FR)

(72) Inventors: Julien Marc Nicolas RAMBAUD, Blagnac (FR); Valentin Antoine Maxime MESNIL, Blagnac (FR); Sébastien VIEILLARD, Blagnac (FR); Guillaume PORTE, Blagnac (FR)

(73) Assignee: SAFRAN ELECTRICAL & POWER, Blagnac (FR)

(21) Appl. No.: 19/136,161

(22) PCT Filed: Nov. 30, 2023
(86) PCT No.: PCT/FR2023/051874

§ 371 Date: Jun. 5, 2025

(30) Foreign Application Priority Data
Dec. 7, 2022 (FR) FR2212905

(51) Int. Cl. H02P 25/06; B64D 31/09; B64D 31/16; H02P 29/028

(52) U.S. Cl. CPC H02P 25/06; B64D 31/09; B64D 31/16; H02P 29/028

(57) ABSTRACT

An aircraft electrical propulsion system including at least one electric motor, a setpoint of which is computed along a first channel including a first command unit and along a second channel including a second command unit, the at least one electric motor including a rotor and two star-connected stators and the first command unit of the first channel is connected to one of the two star-connected stators via a first power converter and the second command unit of the second channel is connected to the other of the two star-connected stators via a second power converter, each of the first and second channels being dimensioned to half of the total power of the at least one electric motor.

This invention relates to the field of aircraft electrical or hybrid propulsion and it more specifically relates to an electrical propulsion system architecture.

### PRIOR ART

It is known that aeronautical controls require high reliability levels of aircraft propulsion systems in order to meet safety specifications. Often these reliability levels manifest as redundancies of certain members to palliate their primary failure. This is particularly the case for so-called ECS (Electronic Control System) electronics providing the thrust control functions, the single-fault failure of which is only tolerated by the aeronautical standards on the condition that it does not give rise to more than 15% of performance loss.

Thus, in the context of thermal propulsion architectures, a heat engine is associated with a control system called FADEC (Full Authority Digital Engine Control) which is used to interface with the thrust command orders of the pilot and to control the thrust of the engine based on the parameters transmitted to it by a series of sensors. In so-called Dual FADEC architectures, this critical function of engine control is totally redundant to allow the single fault tolerance of any member of this FADEC.

Similarly, in the context of the new electrical propulsion architectures, the electrical part comprises not only a digital control part, but also an electrical power converter of inverter type and the electrical part of the motor formed by its stator windings. To allow the single fault tolerance of any part of the ECS in the same way as a heat engine, this ECS is also completely redundant.

Such a redundancy is however not without drawbacks since it involves doubling the elements of the electrical power converter and the stator windings of the engine motor which are voluminous and heavy.

In addition, to ensure the takeover of the control of the second ECS channel (the redundant channel) in the event of a failure of the first one, it is necessary to make provision for a system of switching to the motor of contactor type, which, if it is set up at the outlet of the power converter, must therefore be dimensioned for the high electrical currents of the motor and not only for the command signals, as could sometimes be the case in thermal architectures of Dual FADEC type.

This choice of architecture therefore still involves consequences on mass and volume by comparison with a single line to ensure the desired level of redundancy. Furthermore, this choice of architecture with redundancy and a potential additional switching system complicates the system and degrades the availability of the product due to a higher fault rate.

### SUMMARY OF THE INVENTION

This invention thus has the main aim of palliating the aforementioned drawbacks by making provision for an architecture guaranteeing an ideal trade-off between availability and reliability, and making it possible to fulfil the safety objectives while avoiding making elements of high volume or mass redundant.

These aims are achieved by an aircraft electrical propulsion system including at least one electric motor, a setpoint of which is computed along a first channel comprising a first command unit and along a second channel including a second command unit, characterized in that the at least one electric motor includes a rotor and two star-connected stators and in that the first command unit of the first channel is connected to one of the two star-connected stators via a first power converter and the second command unit of the second channel is connected to the other of the two star-connected stators via a second power converter, each of the first and second channels being dimensioned to half of the total power of the at least one electric motor.

Thus, without having to double the power parts, redundancies are limited to low-level electronic parts which have little impact on the onboard weight and volume while allowing a good trade-off in terms of safety and availability. By taking advantage of intrinsic transient capacities, this architecture makes it possible to compensate for a limited time for all or part of the power lost on the single fault.

Preferably, the first and second power converters are supplied by two high-voltage DC power sources independent of one another and each dimensioned to half of the total power.

Advantageously, the first and second command units are supplied from first and second low-voltage DC power sources.

The aircraft propulsion system can further include a diode OR logic to supply the first and second command units from one or the other of the first and second low-voltage DC power sources.

Preferably, the wound stators include more than three phases on one and the same star or are wound over several three-phase stars with separate neutrals and wherein the number of channels is equal to or greater than two, typically four or six.

The invention also relates to a control and monitoring system for an aircraft electric motor, comprising a control system configured to command at least one electric motor, the control system comprising: a first channel comprising a first command unit configured to compute a setpoint for the at least one electric motor as a function of the measurement information coming from a measurement system, a second channel comprising a second command unit configured to compute a setpoint for the at least one electric motor as a function of the measurement information coming from the measurement system, characterized in that the at least one electric motor includes a rotor and two star-connected stators via a first power converter and the second command unit of the second channel is connected to the other of the two star-connected stators via a second power converter, each of the first and second channels being dimensioned to half of the total power of the electric motor.

Preferably, the command units have a dissimilar design to avoid any common fault.

According to the envisioned embodiment, the first power converter is connected to a first monitoring unit and the second power converter is connected to a second monitoring unit, or else the first and second power converters are connected to a common monitoring unit.

Preferably, the monitoring units each include a reset input in the event of functional failure of these monitoring units.

Advantageously, the measurement system delivers the same data to the command units and to the monitoring units of one and the same channel.

Preferably, the monitoring units are able to shut down the power converters in the event of failures being detected in these data.

### BRIEF DESCRIPTION OF THE DRAWINGS

Other features and advantages of this invention will become apparent from the description given below, with reference to the appended drawings which illustrate an exemplary embodiment thereof without any limitation and on which:

FIG. 1 illustrates an architecture of an aircraft electrical propulsion system in accordance with the invention,

FIG. 2 shows a first example of distribution of the command and monitoring functions applied to the architecture of FIG. 1, and

FIG. 3 shows a second example of distribution of the command and monitoring functions applied to the architecture of FIG. 1.

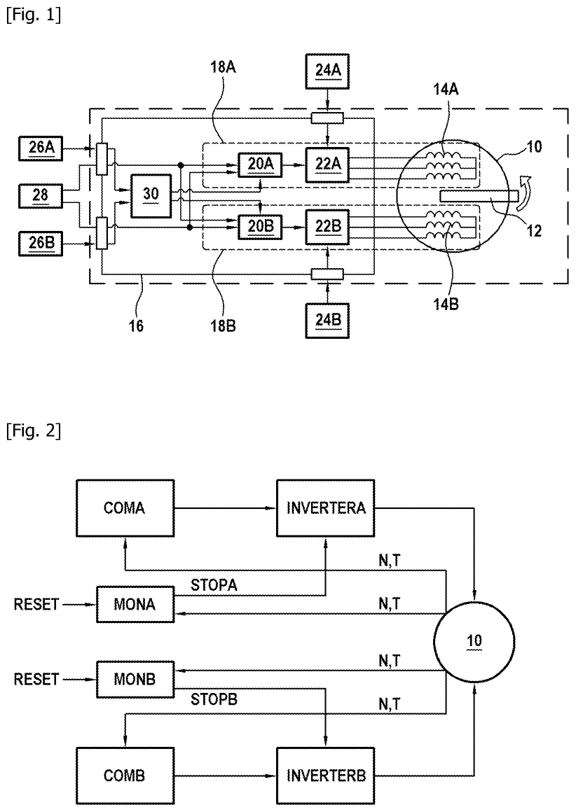

### DESCRIPTION OF THE EMBODIMENTS

The principle of the invention is based on the possibility of constructing electric motors by dividing the stator into two stars each supplying half the power to a single rotor. This dimensioning to half of the electrical power thus has the advantage not only of constantly keeping half of the power following a single fault on one or the other of the two channels, but also, by taking advantage of the transient capacities of the electrical components, of allowing, using the remaining channel, the supply of a higher transient power which can compensate for all or part of the power supplied at the time of the fault.

The architecture of the electrical propulsion system is organized around an electric motor 10 including a rotor 12 and two star-connected stators 14A, 14B supplied by an electronic control system (ECS 16) defining two separate channels 18A, 18B each dimensioned to half of the total power of the electric motor. The first channel 18A includes a first command unit 20A connected to one 14A of the two star-connected stators via a first power converter 22A and the second channel 18B includes a second command unit 20B connected to the other 14B of the two star-connected stators via a second power converter 22B. The two power converters (conventionally inverters) are each supplied independently from a high-voltage DC power source (24A, 24B) each delivering half of the total power and both the command units are each supplied from a low-voltage DC power source 26A, 26B.

This particular configuration allows a significant saving in mass and volume since the power converters have a power level divided by two. Furthermore, it allows a partial single fault tolerance with high performance since not only does half of the total power of the electric motor remain available at continuous rating in the event of an internal failure of an electrical element of the propulsion line (stator of the motor or of the ECS), but it can also possess a transient power on a single channel equal to all or part of the total maximum motor power (when both channels are supplied together), without overdimensioning, owing to the intrinsic capacities of the permanent-magnetic synchronous electric machines to be able to operate in overspeed in a transient manner.

This partial tolerance is also applicable to a single fault of the high-voltage power supply of the aircraft due to the fact that both the channels 18A, 18B are supplied with high-voltage DC power (HVDC) of half of the power by the two independent sources 24A, 24B. Thus, the failure of the power supply source or of the electrical harness once again only causes the loss of half of the power of the electric motor.

The invention moreover makes it possible to cover a complete tolerance to external faults of the low-voltage DC power sources 26A, 26B and of the command signals coming from the FADEC 28 of the aircraft, due to the interfacing of the ECS, over two separate inputs, with these command units and with the low-voltage DC power supply.

Each interface therefore receives the same information from the aircraft, making it possible to be independent of the failure of a member of the aircraft, for example the thrust lever or the control panel, or the electrical connection harness. Internally to the ECS, management of the segregation makes it possible to ensure that each channel of the ECS receives the redundant command signals (digital and/or wired).

Finally, a diode logic 30 of OR function type enables the interface with the low-voltage DC power sources, ensuring tolerance to a fault in one of these two sources. Note that the redundancy of these signals and of these interfaces has little impact from a mass and volume point of view.

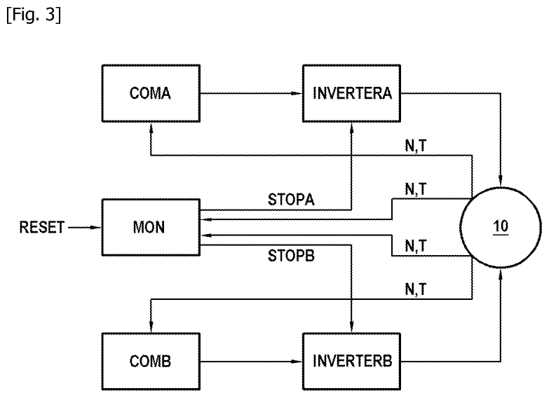

FIGS. 2 and 3 very schematically illustrate two examples of the device for regulating and monitoring an aircraft engine comprising a control system, an actuation system comprising at least one electric motor, and a measurement system (for example: temperature, speed, torque etc.)

The control system makes it possible to drive the electric motor 10 according to a predetermined setpoint according to measurement information from the measurement system. This setpoint can be a position, speed or torque setpoint according to the parameter of the commanded motor. It comprises the two channels 18A, 18B, each configured to compute a setpoint and control the electric motor according to this setpoint. More generally, the different channels of the control system are therefore configured to determine one or more setpoints (according to the number of electric motors concerned).

On FIG. 2, the first channel and the second channel each comprise a command unit COMA, COMB configured, on the one hand, to compute a setpoint in a first way and, on the other hand, to drive the electric motor according to this setpoint via the power converter 22A, 22B.

Associated with one and the other of the first channel and the second channel, a monitoring unit MONA, MONB is for example configured to compute a setpoint for the electric motor in a second way, different from the first way computed by the command unit COMA, COMB. In particular, the computing of the setpoint by the monitoring unit MONA, MONB is diversified (both materially and functionally) by comparison with that implemented by the command unit COMA, COMB. The monitoring unit MONA, MONB in particular makes it possible to check that the command unit COMA, COMB is functioning within its operational envelope (for example a predetermined speed interval). Specifically, this monitoring unit monitors the proper operation of the command unit based on the same data with the authority to put the channel into shutdown by shutting down (STOPA, STOPB) the power converter in the event of detection of a failure (overspeed or excessive temperature) which are normally taken into account under normal operation.

In general, the monitoring unit is necessary to possess a breaking means “independent” of the command unit, in order to guard against feared events in the aeronautical certification sense (Catastrophic or Hazardous). It is therefore an ultimate safety barrier in the event of failure of the command unit.

Similarly, the two command units COMA and COMB can have a dissimilar design, i.e. different in its components and/or its onboard technologies, and the two stators can either share the same magnetic circuit (laminated core) with a segregated geometrical distribution, or have two different magnetic circuits, or else not have any ferromagnetic core. This makes it possible to eliminate the risk of common faults related to design which could cause the simultaneous loss of both power channels. This dissimilar architecture is particularly justified on aeronautical platforms including a large number of electric motors, such as new airplanes with distributed propulsion or Vertical Take-Off and Landing aircraft (VTOL).

Note that in the proposed architecture exchanges (not illustrated) exist between the two command units COMA, COMB and are necessary for its correct operation. On the other hand, the communication between the command units and the monitoring units can be optional, the loss of data not having any adverse effect on performance.

With FIG. 3, the architecture is optimized by grouping the two monitoring units into a single common unit MON while being compatible with availability and safety objectives, in particular by the use of a reset means (RESET) to restart the monitoring unit in the event of a functional failure. It should be noted that the loss of this common unit MON does not entail any loss of performance but only the loss of a level of safety, which is however acceptable until the end of the mission for example.

The measurement system transmits information from sensors to the command units COMA, COMB and monitoring units MONA, MONB of the control system. The measurement resources can be common (shared) or segregated (similar or diversified) and potentially spatially separated, between the different command and monitoring units of the control system.

Note that while the invention has been described with regard to an architecture shared between two channels managing half of the power, this number of channels is in no way limiting and can for example be greater than two (typically four to six). It is also possible to envision a sharing into a larger number n of channels making it possible to conserve n−1/n power capacity during an electrical failure. For example, assuming a power of 50 KW per channel, one may envision the command of a motor of 1 MW with 20 channels set up in parallel.

Furthermore, each of the channels of the electric motor and of its command can have more than 3 phases (minimum number for a stator) on one and the same star. Thus the stator can be multi-phase (typically 5, 6 or 7) and/or include several three-phase stars disposed in parallel (with separate neutrals). In this case, the power converter will include as many inverter arms as there are phases on the stator and the number of command and monitoring units will of course be adapted as a consequence.

Similarly, another embodiment allows the dimensioning of each channel with a power capacity greater than Ptotal/n, at least during a transitional period. For example, for a total desired power of 100 KW, a sharing into two channels gives a dimensioning of each channel of 50 kW. Considering an additional transient power capacity of 50% for each channel, i.e. 75 KW, a single failure leading to the loss of one channel will still allow the motor to dispose, transiently, of this power of 75 KW, which is therefore 75% of the initial power. This operating mode can allow the safety objective to be upheld in the event of a first failure during these transient operations while limiting overdimensioning.

Thus, the invention relates to an electrical propulsion system architecture offering an ideal trade-off between availability and reliability while fulfilling the safety objectives of:
tolerance to external faults on low-level interfaces (power supply and digital communications), and
partial tolerance to internal electrical faults while avoiding making elements of high volume or mass redundant.

It allows both the supply of enough transient power to ensure the ascent of the aircraft, allowing it to gain a safe altitude, and the supply of enough DC power to allow the aircraft to maintain its altitude and allow it to return to a landing area.

1. An aircraft electrical propulsion system including at least one electric motor, a setpoint of which is computed along a first channel comprising a first command unit and along a second channel including a second command unit wherein the at least one electric motor includes a rotor and two star-connected stators and in that the first command unit of the first channel is connected to one of the two star-connected stators via a first power converter and the second command unit of the second channel is connected to the other of the two star-connected stators via a second power converter, each of the first and second channels being dimensioned to half of the total power of the at least one electric motor.

2. The aircraft electrical propulsion system as claimed in claim 1, wherein the first and second power converters are supplied by two high-voltage DC power sources independent of one another and each dimensioned to half of the total power.

3. The aircraft electrical propulsion system as claimed in claim 1, wherein the first and second command units are supplied from first and second low-voltage DC power sources

4. The aircraft electrical propulsion system as claimed in claim 3, further including a diode OR logic to supply the first and second command units from one or the other of the first and second low-voltage DC power sources.

5. The aircraft electrical propulsion system as claimed in claim 1, wherein the wound stators include more than three phases on one and the same star or are wound over several three-phase stars with separate neutrals and wherein the number of channels is equal to or greater than two, typically four or six.

6. A control and monitoring system for an aircraft electric motor comprising a control system configured to command at least one electric motor, the control system comprising: a first channel comprising a first command unit configured to compute a setpoint for the at least one electric motor as a function of the measurement information coming from a measurement system, a second channel comprising a second command unit configured to compute a setpoint for the at least one electric motor as a function of the measurement information coming from the measurement system, characterized in that the at least one electric motor includes a rotor and two star-connected stators and in that the first command unit of the first channel is connected to one of the two star-connected stators via a first power converter and the second command unit of the second channel is connected to the other of the two star-connected stators via a second power converter, each of the first and second channels being dimensioned to half of the total power of the electric motor.

7. The control and monitoring system for an aircraft electric motor as claimed in claim 6, wherein the command units have a dissimilar design to avoid any common fault.

8. The control and monitoring system for an aircraft electric motor as claimed in claim wherein the first power converter is connected to a first monitoring unit and the second power converter is connected to a second monitoring unit.

9. The control and monitoring system for an aircraft electric motor as claimed in claim 6, wherein the first and second power converters are connected to a common monitoring unit.

10. The control and monitoring system for an aircraft electric motor as claimed in claim 8, wherein the monitoring units each include a reset input in the event of functional failure of these monitoring units.

11. The control and monitoring system for an aircraft electric motor as claimed in claim 6, wherein the measurement system delivers the same data to the command units and to the monitoring units of one and the same channel.

12. The control and monitoring system for an aircraft electric motor as claimed in claim 11, wherein the monitoring units are able to shut down the power converters in the event of failures being detected in these data.
